(19) United States
(12) Patent Application Publication
(10) Pub. No.: US 2004/0094511 A1
(43) Pub. Date: May 20, 2004

(54) Method of forming planar Cu interconnects without chemical mechanical polishing

(75) Inventors: Soon-Cheon Seo, White Plains, NY (US); Wei-Tsu Tseng, Hopewell Junction, NY (US); Darryl D. Restaino, Modena, NY (US); James E. Fluegel, Rhinebeck, NY (US); Richard O. Henry, Wappingers Falls, NY (US); John M. Cotte, New Fairfield, CT (US); Mahadevaiyer Krishnan, Hopewell, NY (US); Hariklia Deligianni, Tenafly, NJ (US); Philippe Mark Vereecken, Sleepy Hollow, NY (US); Stephen E. Greco, Lagrangeville, NY (US)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation, Armonk, NY

(21) Appl. No.: 10/300,468

(22) Filed: Nov. 20, 2002

(51) Int. Cl. C23F 1/00; B44C 1/22; C03C 15/00; C03C 25/68

(52) U.S. Cl. 216/83

(57) ABSTRACT

A method for controlling the shape of copper features, having the following steps:

a) plating a copper feature with a predetermined final shape onto a copper seed layer in a plating bath for a first plating time using a first plating method, wherein the first plating time is less than the total length of time necessary to plate the substantially all of the final shape; and

b) electrically treating the plated copper feature in a copper plating bath for a second period of time, the second period of time sufficient to at least form the predetermined final shape.

### FIELD OF THE INVENTION

The present invention relates generally to semiconductors and more specifically to electroplating and planarization of copper.

### BACKGROUND OF THE INVENTION

In the manufacturing of integrated circuits, after the individual devices, such as the transistors, have been fabricated in the substrate, they must be connected together to perform the desired circuit functions. This connection is generally called the interconnect metalization process and is performed using a number of different photolithographic and deposition techniques.

One method of forming line/via interconnect metalizations is called the dual damascene method. The shape for the line and via are both formed using photolithographic and rective ion etching methods prior to filling either the line or the via with metalization. The line and via are then filled with the desired metalization. Where the metal filling the line and via are copper there are additional steps which must occur prior to filling the line and via with copper. Copper (Cu) is typically electroplated into lines and vias and a seed layer is typically deposited to facilitate the electroplating. The seed layer is usually deposited in addition to the line/via copper diffusion barrier (liner) layer(s). Once the copper seed layer has been deposited then the copper can be electroplated into the line/vias.

Challenges exist in the creation of Cu interconnect metalizations (features). The size of the Cu features is decreasing and the density of features is increasing.

In addition to the fabrication complexities introduced by decreasing Cu feature size, the use of softer, more pliant dielectric materials with a dielectric constant of at most about 3.0 (K≦3.0), called low-k dielectrics as a group, pose particular problems when used to fabricate copper metallic semiconductor interconnect features. Low-k dielectrics are more susceptible to damage during a chemical-mechanical polishing (CMP) cycle because they are generally not as mechanically resilient as the high dielectric constant materials traditionally used in semiconductor interconnect fabrication. As a result, alternate methods of planarizing metal interconnects have to be developed.

As the device shrinks, it is very challenging not only to fill small feature vias and trenches without voids but also to grow bamboo-like copper grains after plating in narrow features. Typically, the plated Cu receives low temperature anneal (100-200° C. for about 60 minutes) to “grow” the copper grain diameter larger than the trench width. This type of growth is called bamboo-like grain growth and can enhance reliability performance. However, developers predict that as feature size shrinks, there might be a limit to growing bamboo-like grains in narrow features at low temperature anneal. Thus, developers may be required to anneal at higher temperatures (200-400° C.) for achieving bamboo-like grain growth in narrow features (<90 nm). However, the disadvantage of higher temperature anneal is that copper can dewet at the bottom of the vias and cause circuits opens in via chains.

Additionally, having a predictable, predetermined Cu grain size is advantageous and helps ensure reliability of copper features. The probability that small grain size copper will remain after a low temperature anneal step increases as feature size decreases. For that reason, it is desirable to control the factors that affect grain size growth during the plating of the copper.

The use of low-k dielectric materials is not the only challenge facing semiconductor designers and fabricators. As the size of the features in metal semiconductor interconnects decreases, it can become more difficult to both consistently fill and achieve planar plating fill in narrow and wide lines. By narrow it is meant high aspect ratio features. For example, when openings for copper interconnects are plated in a copper plating bath, narrow and/or nested opening features can obtain a “bread-loafing” like overburdening if plating is continued for a length of time sufficient to fill wide copper features. The use of levelers in the Cu plating baths can modify these effects. Even then, in some cases the widest features experience a phenomena called dishing or underfill.

Thick overburden is undesirable for a number of reasons. Another reason is that planarization time is a function of overburden thickness. The thicker the overburden the longer it can take to planarize the copper. One of the more important reasons is that grain growth will start at the top of a feature if given the opportunity. Overburden regions create areas that can cause grain growth nucleation. Since it is desirable to push the grain growth to narrow features at high temperatures it is advantageous to at least minimize and at best eliminate overburden. Thus, there remains a need to provide planar, reliable large grain copper interconnects in low-k dielectrics.

### SUMMARY OF THE INVENTION

It is an object of the instant invention to provide a method for planarizing plated copper interconnects.

It is also an object of the instant invention to provide a method which reduces the occurrence of overfilling (overburden) during the plating of copper interconnects.

It is yet another object of the instant invention to provide a method for providing planar plated copper interconnects which are disposed in a low-k dielectric without the use of CMP.

### BRIEF DESCRIPTION OF THE DRAWINGS

FIG. 1 is a cross sectional view of the existing art showing the openings created for filling with copper metalization

FIG. 2 is a cross sectional view of the existing art showing an first intermediate processing step for copper electroplating processing of semiconductor interconnects.

FIG. 3 is a cross sectional view of the existing art showing a second intermediate processing step for copper electroplating processing of semiconductor interconnects.

FIG. 3a is a cross sectional view of the existing art showing the state of the openings during a deposition process.

FIG. 4 is a cross sectional view showing a first processing step of the instant invention.

FIG. 5 is a cross sectional view showing the final structure achieved by using the subject matter of the instant invention.

### DETAILED EMBODIMENT

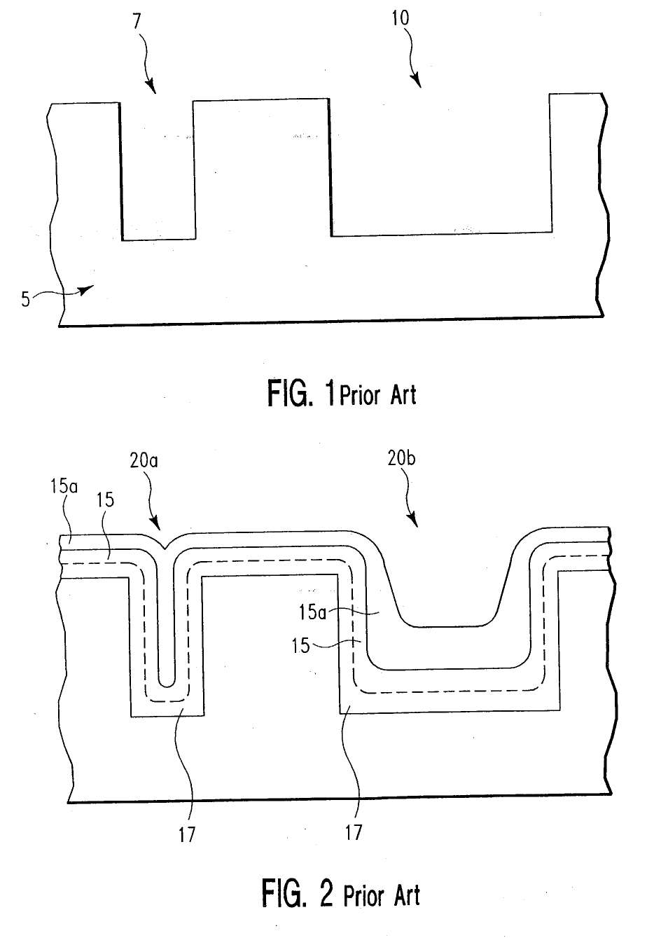

The method developed in the instant invention provides a method of planarizing Cu interconnects while minimizing the mechanical stresses to the surrounding dielectric and also provide a method to improve recrystalization in narrow features. That is to say, the method of the instant invention can provide a planarized Cu interconnect without CMP. Referring to FIG. 1, which, like all of the figures, is presented for illustration purposes only and not drawn to scale, shows partially filled copper interconnects in a dielectric. Narrow, 7, and wide, 10 structures (features) disposed in dielectric, 5, are illustrated. The copper features in FIG. 1 were plated using an electroplating bath. More preferably, the partially filled copper features were formed using an acid electroplating bath. As can be seen (the narrow and wide features, 5 and 7 respectively) copper fills the narrow features more quickly than the wide features. In current generation copper interconnect formation there are various methods used to try and control the rate at which the copper is plated. One method of guiding the formation of the copper is to employ accelerators, suppressors and levelers.

Suppressors are typically polymers that adsorb evenly on the copper surface and act to effectively reduce the number of free sites for adsorption of accelerators and inhibit copper deposition on the entire copper surface. Accelerators are typically organic disulfides that enhance or accelerate copper deposition due to strong adsorption on the copper surface and through a complex electrochemical an chemical mechanism that is known in the art. There is competition in the adsorption between accelerators and suppressors and typically the accelerator tends to weaken adsorption of the polymer and lift if off the surface. The reaction produces of accelerators tend to accumulate over time in narrow features resulting in accelerate bottom up fill (or superfill) phenomena.

As a consequence of accelerator and suppressor use narrow features fill quickly and breadloafing occurs due to local action of accelerator above narrow features in the electroplating bath. However, wide features (features with an aspect ratio of less than 1) display conformal electroplating. Levelers are used to reduce the overburden topography in narrow and wide features. Typically, increasing leveler concentration can cause electroplating fill problems. Thus, all additives are balanced to completely fill without voids in small features but to reduce significant topography so that CMP can still planarize all features. Significant underfill can cause dishing problems after CMP and it can cause numerous problems when building multiple copper levels.

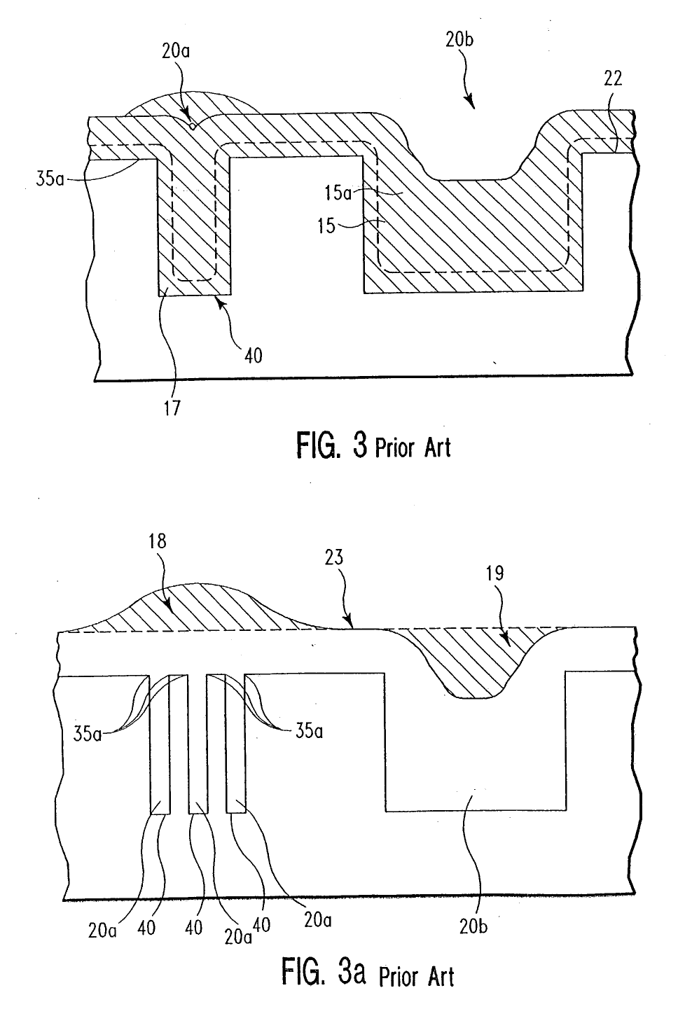

It is well known in the art that copper plating fill does not occur evenly. Copper plating fills more quickly in narrow features than wide features. For example, as shown in FIG. 2, during the electroplating process, copper will start to plate on the seeded dielectric, 17. As plating continues, the copper will continue to plate, 15a, on the seeded dielectric, 17. According to current generation copper electroplating technology copper interconnects, 20a, 20b, with different shapes as shown in FIG. 3 are created. As can be seen in FIG. 3, a plated copper bump, 25a, extends beyond the plane created by the top surface, 22, of the seeded dielectric, 17 the narrow copper interconnects, 20a are disposed in. Further, as can be seen from FIG. 3a, that not all of the current layer copper interconnects, 20a, 20b, have the same shape. FIG. 3a also shows the overburden region, 18, and the “underburden” region, 19. Overburden is usually measured from the “field”, 23. By “field” it is meant the thickness of plating from the surface of the dielectric where there is no opening. The different shapes can make CMP more difficult as CMP endpoint will be reached in some areas before others. Traditional dielectrics have typically mechanically robust enough to withstand the demands of a CMP cycle.

Another consideration when selecting a copper interconnect formation process is the thermal strains associated with annealing the copper after electroplating. Traditionally, copper anneals have taken place at temperatures of about 100-200° C. for about 60 minutes. Designers contemplate that higher temperatures will be necessary in the future due, at least in part, to the decreasing size of individual copper interconnects and the increased density of the copper interconnects.

Copper interconnects are treated thermally to affect the final copper grain size. The grain size of a copper interconnect can affected at different stages of copper interconnect formation. For example, it has been found that grain growth of the plated copper nucleated from overburden or sharp corners. 20a in FIG. 3a shows the overburden and 35a shows the sharp corner where nucleation could take place. When grain growth occurs at the top of a feature copper can dewet or be “pulled up” at the bottom of the vias, 40, (especially narrow vias) and cause electrical opens between different copper interconnection levels. If the overburden thickness is reduced, Cu grain growth should happen mainly inside the features at higher temperatures and reduce the occurrence of dewetting at the bottom of vias.

In the instant invention, it is an element of this embodiment to form a substantially planar copper layer for both narrow and wide lines/vias. It is preferred, but not necessary that the planar copper layer be substantially planar with the top surface dielectric that the feature is disposed within. Minimizing overburden can reduce raw processing time as it may reduce the time associated with traditional planarization techniques (CMP).

As stated infra, when electroplating copper fill time is different for narrow vs. wide features. In a first embodiment of the instant invention, a current level of openings, which are to become current level lines and vias, are created in a current level of dielectric by any means known in the art. Preferably the dielectric is a low-k dielectric and the openings are formed using photolithographic and reactive ion etching methods. The openings would then be treated to enhance later electroplating. Preferably, a liner comprising metallic elements would be deposited in the openings and a seed layer deposited thereafter. More preferably, the liner would comprise a copper diffusion layer like a tantalum containing compound and the seed layer would comprise a conducting layer which allows plating like copper. Next, copper would be plated into the openings in a copper plating bath. Preferably, the plating bath would be an acid plating bath and plating additives (like accelerators, suppressors and/or levelers) would be employed as needed.

One of the factors that determines the amount of interconnect filling in a copper plating bath is electroplating time. The amount of time that copper is traditionally plated to ensure fill of both narrow and wide features using forward current electroplating shall be called the total electroplating time. It is an element of the instant invention that the forward current electroplating be stopped prior to the time when overburden ends. The overburden phase being defined as overburden commence time—overburden completion time. It is preferable that the forward current plating be stopped when the depth of the copper over the narrow features is greater than the predicted “field” thickness of the copper on the top surface of the dielectric where there is no opening. It is also an element of the instant invention that less than all of the interconnect feature openings would be filled at the time that the forward current plating is stopped. It is preferable that the forward current plating comprise DC plating and that it continue until at least some of the narrow features are filled (for at least 20% and at most 80% of the total electroplating time).

For example, the PPR phase could begin prior to any overburden being formed or when the narrow features (20a) have the overburden as shown in FIG. 3 and the wide features (20b) have the underfill as shown. Alternatively, the PPR phase could commence wehtn the narrow features 20a, and the wide features 20b are as shown in FIG. 2. That is to say that the narrow features have not yet grown any significant overburden. In a preferred embodiment, at least some overburden would have formed in the narrow openings. It is an element of the instant invention that the copper electroplating continue at least until all of the openings are substantilly filled using a periodic pulse reverse (PPR) electroplating process. It is preferred that the form of forward current electroplating used be direct current electroplating (DC plating).

PPR combines forward current (plating mode) and pulses of reverse current (deplating/etch mode). The current for the reverse plating current would be account 2-5 times that of the forward current and the reverse plating time would be at least 5% at most 33% of the forward plating time. A preferred forward plating current would be the 3 times the forward plating current. Also preferably, the duration of each forward and reverse mode can range from milliseconds to the seconds. Additionally, it is preferable that once the PPR phase starts, for each second of forward plating there be a 20 millisecond reverse pulse. For example, typical DC plating (forward current electroplating) on a 200 mm diameter wafer may start with hot entry and then increase to a 3-5 amps plating step for 20-40 seconds. For the PPR phase, the DC plating would be at 3-5 amps for 20 millisecond for filling features for 0.09-0.20 μm. Each 20 millisecond DC plating would be followed by a reverse pulse at 9-15 amps for 1 millisecond. This sequence would be preferably be repeated under the same conditions for the duration of the PPR phase. However, the inventors contemplate that the ratio of DC plating to PPR could be variable. One can change the reverse pulse conditions during plating, hence having multiple different PPR modes for the PPR phase. While it is difficult to predict exactly what the PPR processing time should be since there may be a delay in the PPR from the PPR power supply but the following equation will generally give you the predicted overburden using the PPR process:

overburden thickness=

(cf×cft−cr×crt)×dr×(dep rate/current)

where

cf=forward current

cft=duration of forward current

cr=periodic pulse reverse current

crt=duration of period current

dr=number of pulses

where dr=[(cft+crt)/total PPR time] and

dep rate=(thickness/time)

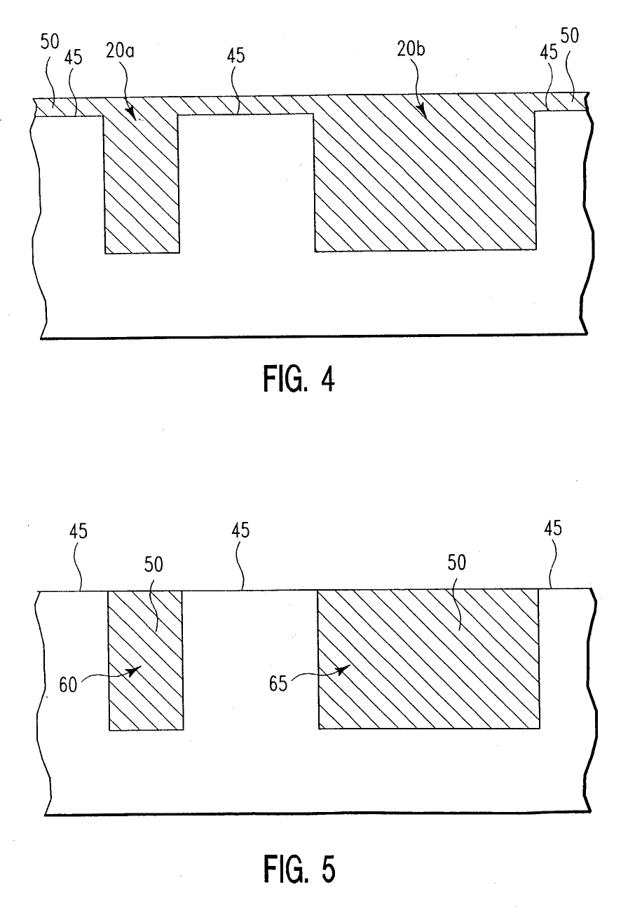

It is preferable that the DC plating process be ended when at least some narrow features are filled and the overburden profile shown in 20a of FIG. 3 is created. After the completion of the PPR processing step the interconnect fills for 20a, and 20b would be as shown in FIG. 4. As can be seen in FIG. 4, the copper, 50 deposited during the formation of the interconnects is planar. That is not to say that the copper is in the same plane as the top of the dielectric, 45, that the interconnect was formed in. In fact, while preferable, depending on the size and density of the interconnects, it may not be possible to create a copper interconnect structure that is planar with the surface of the interconnect using only forward current plating and PPR. Where the copper necessarily extends above the plane created by the top of the dielctric the copper interconnect is disposed in, further steps would have to be employed to create a copper feature that was planar with the dielectric it is disposed in. It should be noted that other processing steps may occur between the electroplating process and the planarization process step. Specifically, it is contemplated that the plated copper interconnects may be annealed prior to the planarization. The anneal step may be performed by any means known in the art. The methods of this invention are independent of any annealing that may be done.

One method of achieving a planar surface is CMP. In the instant invention it is preferable that CMP not be performed. It is preferable that instead of CMP that electroetching be used to create a copper surface that is planar to the dielectric that the copper interconnect is disposed within. Electroetching can also be called electropolishing. The electropolishing could be performed by any means known in the art. Preferably the electropolishing would use at least one of reverse DC electroplating and PPF (periodic pulse forward) electropolishing. If final overburden is substantially planar (as described for FIG. 4 infra), one can perform electropolishing by reversing polarity. However, the final overburden may still have some topography, and PPF can be employed to remove higher surfaces preferentially and planarize the surface while removing copper overburden. The PPR deplating step would be reverse of the PPR plating conditions. First, polarity of the electrode would be reversed and the etching cycle would be followed by a PPR. While it is difficult to predict exactly how long to continue the etching step the following equation gives the length in an ideal case.

Overburden thickness to be removed=

((cr×crt)−(cf×cft))×dr×(etch rate/current)

where

cf=forward current

cft=duration of forward current

cr=periodic pulse reverse current

crt=duration of period current

dr=number of pulses

where dr=[(cft+crt)/total PPR time] and

etch rate=(thickness/time)

The electropolishing would continue at least until the final shape for the copper interconnect desired by the designers is achieved. That is to say that the electropolishing would continue until the copper features were capable of being electrically active with the copper features that would be formed in subsequent processing steps. A preferred final structure is shown in FIG. 5, this structure may be achievable without electropolishing as stated infra. In the preferred final structure, the copper filled (50) narrow feature 60 and wide feature 65 disposed in the seeded dielectric 17 would be planar with the top surface, 45 of the seeded dielectric.

Alternatively, the PPR step can be performed by applying appropriate cathodic potential to deposit copper and anodic potential to dissolve copper under mass transport control. When using this alternative method it is preferable to control the anodic potential during copper dissolution so as to ascertain the copper transport under mass transport controlled conditions.

In a second embodiment of the instant invention, the elements in the copper plating bath would be changed after the completion of the DC plating and prior to the start of the PPR. In that way, impurities that the semiconductor designers deem beneficial can be introduced. Alternatively, it may give the designers the opportunity to suppress impurities and by-products that are deemed detrimental to the electroplating process. For example, additives could affect the plating rate for the copper, the grain size of the copper plated, introduce impurities that will remain in the plated copper interconnect, or chemically bind with plating by-products.

For example, in this embodiment of the instant invention, an accelerator dominated electroplating copper bath is used with a forward current electroplating current. The process step is stopped prior to the time when overburden commences (overburden commence time). It is preferable that the forward current electroplating be DC plating. It is again an element of the instant embodiment that the DC plating in the accelerator-dominated copper electroplating bath continue until at least some of the narrow features are filled and also that less than all of the openings be filled at that time. An accelerator-dominated electroplating bath is a solution containing accelerators and suppressors only or a solution containing accelerators, suppressors and mild levelers in low concentrations. Typically, an accelerator-dominated bath chemistry tends to deposit a pure copper with very small amounts of impurities.

Conversely, a leveler-dominated copper electroplating bath is more advantageous for filling wide features and minimizing overburden. A leveler dominated bath typically contains a strong leveler (organic nitrogen containing compounds) and results in copper deposits with impurities deposited in the tenth-hundredth parts per million by weight range. Therefore, it can be advantageous to change the ratios of accelerators, suppressors or levelers during the PPR phase or to introduce additives. Examples of suppressors that can be adjusted are are polymeric ether compounds such as poyethylene oxide, polypropylene oxide or polymeric glycol, such as polyethylene, polypropylene glycols, polyoxyethylene alcohol or other type of surfactant with improved wetting properties. Accelerators that can be adjusted include small organic compounds that contain thiol, sulfides, disulfides groups such as bis-(sodium-sulfopropyl)disulfide (SPS), 3,3′-dipropanesulfonic acid disufide, 4,5-dithiaoctane-1,8-disulfonic acid or other alkane thiols. Levelers that can be added/adjusted include nitrogen containing compounds with animo- or amine groups or imidazole groups. Examples of these compounds are triethanolamine, 4,5,6 triaminopyrimidine, thiocarbonyl-di-imidazole, mercaptobenzi-imidazoles and other derivatives of these types of compounds.

While the invention has been described in conjunction with a specific best mode, it is understood that many alternative, modifications, and variations will be apparent to those skilled in the are in light of the foregoing description. Accordingly, it is intended to embrace all such alternatives, modifications and variations which fall within the spirit and scope of the included claims.

We claim:

1. A method for controlling the shape of copper features, comprising the steps of:
1) plating a copper feature with a predetermined final shape onto a copper seed layer in a plating bath for a first plating time using a first plating method, wherein the first plating time is less than the total length of time necessary to plate the substantially all of the final shape; and,
2) electrically treating the plated copper feature in a copper plating bath for a second period of time, the second period of time sufficient to at least form the predetermined final shape.

2. The method according to claim 1 wherein the first plating method comprises forward current electroplating.

3. The method according to claim 2 wherein the electrical treatment comprises plating the copper feature from step 1 using a second plating method.

4. The method according to claim 2 wherein the second plating method comprises periodic pulse reverse.

5. The method according to claim 4 wherein the first plating times is at least about 20% and at most about 80% of the total length of time.

6. The method according to claim 5 wherein the second period of time is less than the total length of time sufficient to form substantially all of the predetermined final shape.

7. The method according to claim 6 further comprising the step of electropolishing the copper feature for a third period of time after the step of electrically treating the plated copper feature.

8. The method according to claim 7 wherein the third time period is sufficient to form the predetermined final shape.

9. The method according to claim 8 wherein the electropolishing step comprises a at least one of direct current (DC) electroplating and PPR electropolishing.

10. A method of forming a semiconductor interconnect, comprising the steps of:
1) forming at least one opening in a layer of a dielectric, the dielectric having a top surface, the opening lined with a metallic material capable of having copper electroplated thereon;
2) plating at least one copper feature in at least one opening, said feature having a predetermined final shape, in a plating bath for a first plating time using a first electroplating method, wherein the first plating time is less than the total length of time necessary to plate substantially all of the final shape; and,
3) electrically treating the at least one plated copper feature in a copper plating bath for a second period of time, the second period of time sufficient to at least substantially fill the at least one plated copper feature.

11. The method according to claim 10 wherein the first plating method comprises forward current electroplating.

12. The method of claim 11 wherein the second period of time is sufficient to form a substantially planar copper layer on the top surface of the dielectric.

13. The method according to claim 11 wherein the electrical treatment comprises plating the copper feature from step 1 using a second plating method.

14. The method according to claim 13 wherein the second plating method comprises periodic pulse reverse.

15. The method according to claim 14 wherein the first plating times is at least about 20% and at most about 80% of the total length of time.

16. The method according to claim 15 wherein the second period of time is greater then the length of time sufficient to form the predetermined final shape.

17. The method according to claim 16 further comprising the step of electropolishing the copper feature for a third period of time after the step of electrically treating the plated copper feature.

18. The method according to claim 17 wherein the third time period is sufficient to form the predetermined final shape.

19. The method according to claim 18 wherein the electropolishing step comprises at least one of DC electropolishing and PPR electropolishing.

20. The method of claim 17 further comprising an anneal step prior to the electropolishing step, wherein the at least one copper feature is annealed at a temperature of at least about 60 C.
